(19) United States
(12) Patent Application Publication
(10) Pub. No.: US 2005/0028030 A1
(43) Pub. Date: Feb. 3, 2005

(54) Method, system, and product for improved storage device media verification

(75) Inventors: Thomas R. Forrer JR., Round Rock, TX (US); Jason Eric Moore, Austin, TX (US); Abel Enrique Zuzuarregui, Paige, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/631,061

(22) Filed: Jul. 31, 2003

(51) Int. Cl. G06F 11/00

(52) U.S. Cl. 714/8

(57) ABSTRACT

A system, method, and product are disclosed for verifying a condition of a storage drive's media. A command is received within the storage drive to verify the condition of the storage drive's media. In response to a receipt of the command, the storage drive attempts to read each one of the logical block addresses included in the storage drive. The condition of the media is verified by the storage drive by determining ones of the logical block addresses that are not in a readable condition.

### BACKGROUND OF THE INVENTION

1. Technical Field

The present invention relates generally to the field of data processing systems, and more specifically to rewritable storage devices. Still more particularly, the present invention relates to an improved method, system, and computer program product for verifying the condition of media within a rewritable storage drive.

2. Description of Related Art

Rewritable storage devices, such as hard disk drives, DVD RAM devices, and writable CD drives all need the capability of reading the storage media to determine the condition of the device's media. Presently, the only method to accomplish this task is to have the host computer system transmit individual read, or verify, commands for each logical block address. The host starts at a first logical block address (LBA). The host read and verifies that address. The host then increments the LBA, and reads and verifies that LBA. This process is repeated by the host has incremented through each LBA, and read and verified each LBA. Thus, the host is required to read and verify each logical block address individually until the entire media surface is verified. This requires significant CPU resources from the host, and it ties up limited resources such as PCI bus and SCSI bus bandwidth.

A format unit command has been used in the prior art to set the media of a storage device to a known state. Once the format unit command is executed, a particular initialization pattern is written to the storage device over the existing data on the device. After the initialization pattern is written, all data previously stored on the storage device is lost.

Therefore, a need exists for an improved method, system, and computer program product for verifying the condition of media within a rewritable storage drive.

### SUMMARY OF THE INVENTION

A system, method, and product are disclosed for verifying a condition of a storage drive's media. A command is received within the storage drive to verify the condition of the storage drive's media. In response to a receipt of the command, the storage drive attempts to read each one of the logical block addresses included in the storage drive. The condition of the media is verified by the storage drive by determining ones of the logical block addresses that are not in a readable condition.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation which depicts a network of data processing systems in accordance with the present invention;

FIG. 2 is a more detailed illustration of a computer system that may be used to implement any of the computer systems of FIG. 1 in accordance with the present invention;

FIGS. 3-4 together depict a high level flow chart which illustrates a verification, also called certification, process to verify the condition of a storage drive's media using a single verification command in accordance with the present invention;

FIG. 5 illustrates a high level flow chart which depicts a storage drive responding to a host's queries while the storage drive is verifying its media in accordance with the present invention; and

FIG. 6 depicts a high level flow chart which illustrates a disk drive processing a request for verification percentage completion information in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

A system, method, and product are disclosed in a data processing system for verifying a condition of the media of a rewritable storage drive, such as a hard disk drive, DVD RAM device, or rewritable CD-ROM drive. The storage drive is coupled to a host computer system. The storage drive receives a single command from the host to verify the storage drive's media. In a preferred embodiment, this command is a SCSI command received via a SCSI bus that is used to physically connect the host to the drive.

When the storage drive receives this command, the storage drive will disconnect itself from the host by going offline. The storage drive will then verify the condition of its media by attempting to read all of the drive's logical block addresses. If a logical block address is non-readable or requires error recovery procedures in order to be readable, the storage drive will reassign the logical block address. The storage drive will increment through all logical block addresses until the entire media has been verified. The customer data currently stored in the drive will not be altered by the verification process. After the verification process has been completed by the drive, the storage drive will reconnect to the host by going back online. The storage drive may then report its condition to the host.

In addition, the host may query the drive by sending the drive a Request Sense Command while the drive is offline performing the verification process. The drive will respond to the host with sense data containing the percentage completion of the verification process, a list of LBAs where hard errors occurred during the verification process, and other information.

In this manner, a storage drive may be sent only one command from the host that the storage drive needs to execute in order to verify the condition of the drive's entire media. The drive may also reassign LBAs when executing this command. Recoverable data errors will be reassigned if the Automatic Read Reassign Enable or ARRE bit on Mode Select Page 1 is set to 1. Also, if it is desired to reassign unrecoverable data error LBAS, a bit in the Verify Command Descriptor Block CDB (whose location has to be defined by the ANSI SCSI Committee) has to be enabled. This verification and repair process is executed by the storage device offline so that the host's resources are not occupied in the verification process.

When an LBA is read during the verification process that requires a level or error recovery, that the disk drive vendor believes could result in the data being lost the next time the LBA was read, the LBA is reassigned. When an LBA is encountered that is non-readable, and the hard error reassign bit is set in the Verify CDB, the LBA will be reassigned. Otherwise, if the parameter indicates that reassignment is not permitted, the LBA will not be reassigned. It may be preferred that non-readable LBAs not be reassigned. When an LBA that is non-readable is reassigned, an initialization pattern is written into the data field of the reassigned block. The next time this location is read, no error would occur because the initialization data would be returned If this situation is not preferred, the parameter may be set indicating that reassignment of non-readable LBAs is not permitted.

During the time the drive is performing the verification process, the host system may determine the progress of the verification process by issuing a REQUEST SENSE command to the drive. Bytes 16-17 of the Sense Data field may contain the progress indication field that indicates the current percentage complete. After all of the customer accessible LBAs were read, the drive would reconnect to the SCSI bus and return Good SCSI Completion Status. The G-list, which is a list maintained by the drive that contains a list of all of the LBAs that have been reassigned, would be updated so that the host system could issue the SCSI READ DEFECT LIST command to determine how many LBAs have been reassigned and determine their location. If one or more LBAs were encountered that were non-readable, the drive, when it reconnected to the SCSI bus, would return a Check Condition Completion Status.

The Sense Data would contain a Sense Key of 03 and a Sense Code of 1101 which would indicate that one or more unrecoverable data errors had been encountered during the verification process.

The Request Sense Data has 19 required bytes (defined by the appropriate SCSI Specification) one of them being the additional Sense Length field (byte 7). The LBA location of the hard error locations would be listed after these bytes with any other vendor specific sense data. The length of the additional bytes would be 8 times the number of unrecoverable errors encountered. The maximum number of unrecoverable errors then would be 255 less than the number of sense bytes normally returned by the drive divided by 8. If the number of defective LBAs exceeds this number, the drive would return a Sense Key of 03h with a Sense Code of 11x1 where x would be a hex value assigned by the ANSI (SCSI) Committee to represent the fact that not all of the unrecoverable errors could be reported.

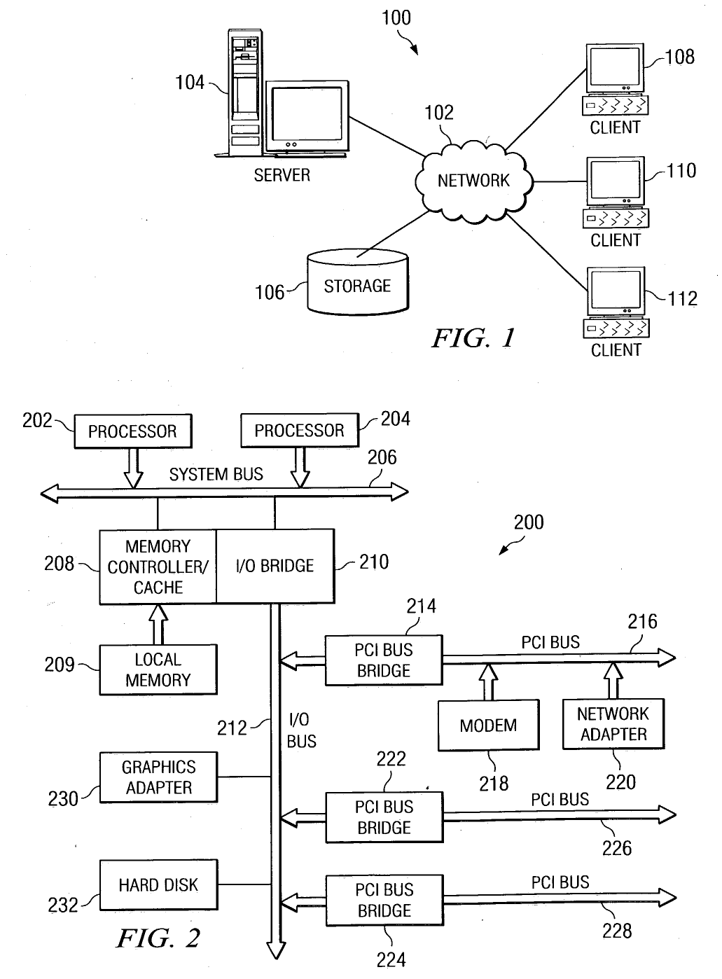

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers, network computers, or other computing devices. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), a wide area network (WAN), or a wireless network. FIG. 1 is intended as an example, and not as an architectural limitation for the present invention.

FIG. 2 is a more detailed illustration of a computer system that may be used to implement any of the computer systems of FIG. 1 in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 drive which is connected to a SCSI Host Bus Adapter which in turn may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

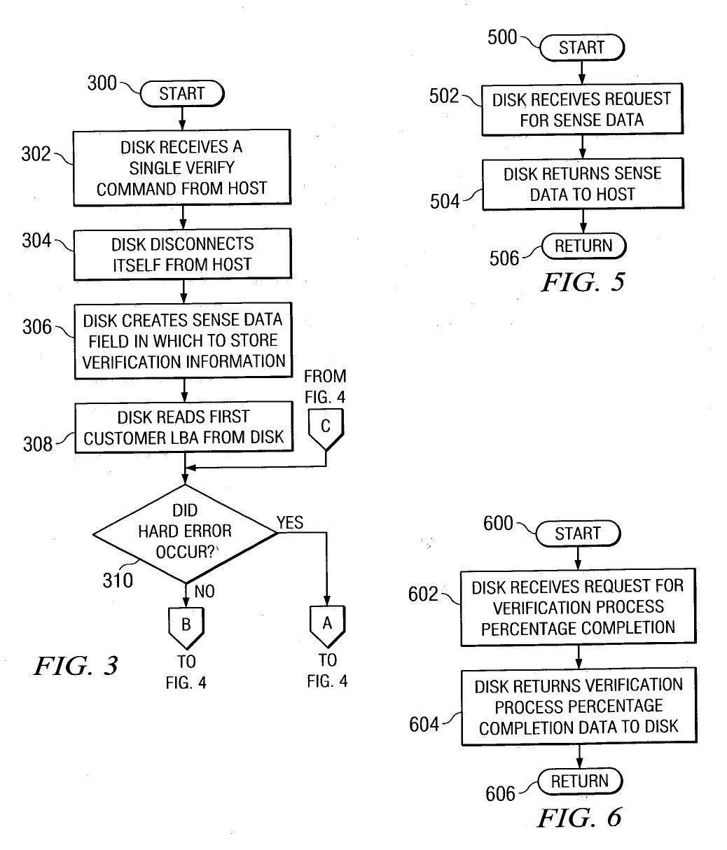

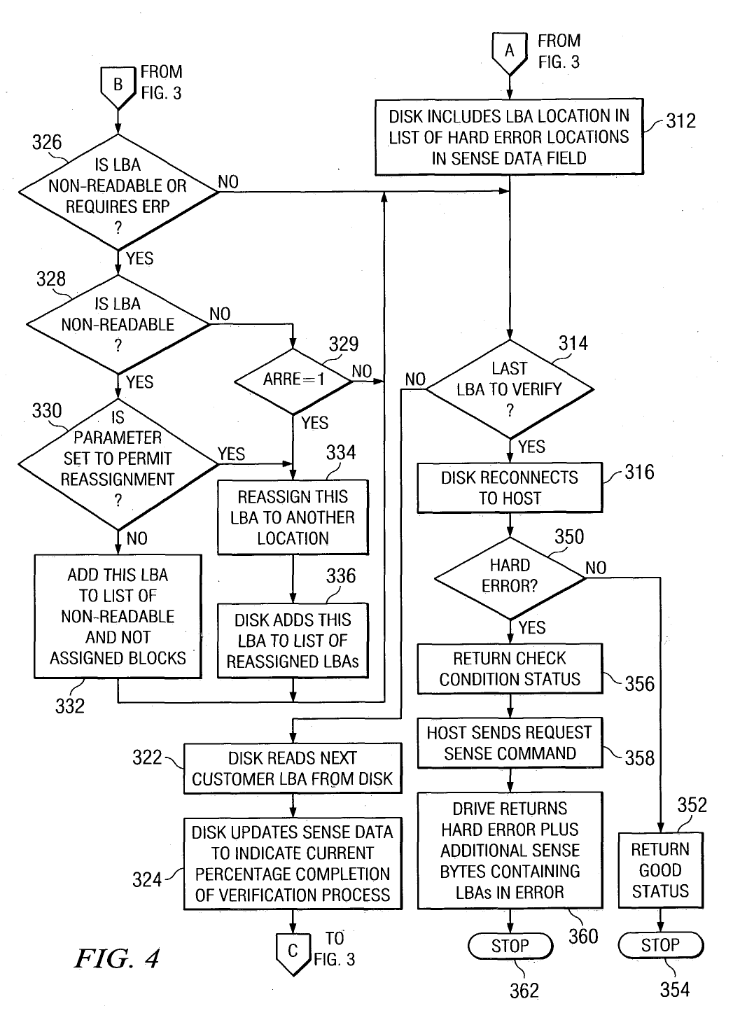

FIGS. 3-4 together depict a high level flow chart which illustrates a verification, also called certification, process to verify the condition of a storage drive's media using a single verification command in accordance with the present invention. The process starts as depicted by block 300 and thereafter passes to block 302 which illustrates a disk drive receiving a single command from a host to verify the condition of the media of the disk drive. Next, block 304 depicts the disk drive disconnecting itself from the host by causing the disk drive to be offline. Thereafter, block 306 illustrates the disk drive creating a sense data field in which to store various verification information that is generated during the verification process. Block 308, then, depicts the disk reading the first customer logical block address (LBA) from the disk.

The process then passes to block 310 which illustrates a determination of whether or not a hard error occurred while attempting to verify the condition of the media of the particular LBA. If a determination is made that a hard error did occur, the process passes to block 312 as depicted through connector A. Referring again to block 310, if a determination is made that a hard error did not occur, the process passes to block 326 as illustrated through connector B.

Block 312 depicts the disk drive including the location of this LBA in the list in the sense data of locations where hard errors occurred. Next, block 314 illustrates a determination of whether or not this is the last LBA location to verify. If a determination is made that this is the last LBA location to verify, the process passes to block 316 which depicts the disk reconnecting itself to the host.

Next, block 350 depicts a determination of whether or not a hard error occurred. If a determination is made that hard errors did not occur during the Verify operation, the process passes to block 352 which illustrates returning a Good Completion Status. The process then terminates as depicted by block 354.

Referring again to block 350, if a determination is made that a hard error did occur during the verification process, the process passes to block 356 which illustrates returning a Check Condition Status. Next, block 358 depicts a host sending a Request Sense command. Thereafter, block 360 illustrates the disk drive returning the hard error information plus additional sense bytes containing an identification the LBA that is in error. The process then terminates as depicted by block 362. Note that the Auto Sense SCSI protocol for handling Check Condition Status could also be used.

Referring again to block 314, if a determination is made that this is not the last LBA location to verify, the process passes to block 322 which illustrates the disk reading the next LBA from the disk. Block 324, then, depicts the disk updating the sense data field to indicate the current completion percentage of the verification process. The process then passes back to block 310 as illustrated through connector C.

Referring again to block 326, block 326 depicts a determination of whether or not this LBA location's media is either non-readable or requires error recover procedures (ERP) to be performed. If a determination is made that this LBA location is readable and does not require ERP to be performed, the process passes back to block 314. Referring again to block 326, if a determination is made that this LBA is either non-readable or requires Error Recover Procedure or ERP to be performed, the process passes to block 328.

Block 328 depicts a determination of whether or not this LBA address is non-readable. If a determination is made that this LBA address is readable, the process passes to block 329 which depicts a determination of whether or not ARRE is equal to 1. If a determination is made that ARRE is not equal to 1, the process passes to block 314. Referring again to block 329, if a determination is made that ARRE is equal to 1, the process passes to block 334. Block 334 depicts reassigning the LBA to another location. Thereafter, block 336 illustrates the disk drive adding this LBA to the list of reassigned LBAs. The process then passes back to block 314.

Referring again to block 328, if a determination is made that this LBA is non-readable, the process passes to block 330 which illustrates a determination of whether or not a parameter is set to indicate that reassignments of non-readable LBAs are permitted. If a determination is made that the parameter defined in the Verify CDB is not set and thus reassignments of non-readable LBAs are not permitted, the process passes to block 332 which depicts adding this LBA to the list of LBAs that are non-readable and that have not been reassigned. The process then passes back to block 314

Referring again to block 330, if a determination is made that the parameter is set to permit reassignment of non-readable blocks, the process passes to block 334 which illustrates reassigning this LBA to another location. Next, block 336 depicts the disk drive adding this LBA to the list of LBAs that have been reassigned. The process then passes back to block 314.

FIG. 5 illustrates a high level flow chart which depicts a storage drive responding to a host's queries while the storage drive is verifying the condition of its media in accordance with the present invention. The process starts as depicted by block 500 and thereafter passes to block 502 which illustrates the disk drive receiving a request for the disk drive's sense data. Next, block 504 depicts the disk drive returning the sense data including the extended Sense Data if hard errors were encountered to the host. The process then returns as depicted by block 506.

FIG. 6 depicts a high level flow chart which illustrates a disk drive processing a request for verification percentage completion information in accordance with the present invention. The process starts as depicted by block 600 and thereafter passes t block 602 which illustrates the disk drive receiving a request for the current percentage completion of the verification process. Thereafter, block 604 depicts the disk drive returning the verification completion percentage to the disk drive.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a storage drive for verifying a condition of said storage drive's media, said method comprising the steps of:
receiving within said storage drive a command to verify said condition of said storage drive's media;
in response to a receipt of said command, attempting, by said storage drive, to read each one of a plurality of logical block addresses included in said storage drive; and
verifying said condition of said media by determining, by said storage drive, ones of said plurality of logical block addresses that are not in a readable condition.

2. The method according to claim 1, further comprising the steps of:
reassigning each one of said ones of, said plurality of logical block addresses that are not in a readable condition to a new logical block address.

3. The method according to claim 1, further comprising the steps of:
determining, by said storage drive, ones of said plurality of logical block addresses that are nonreadable;
determining whether nonreadable logical block addresses are to be reassigned;
in response to a determination that nonreadable logical block addresses are not to be reassigned, leaving said ones of said plurality of logical block addresses that are nonreadable unaltered without reassigning said ones of said plurality of logical block addresses that are nonreadable; and
in response to a determination that nonreadable logical block addresses are to be reassigned, reassigning said ones of said plurality of logical block addresses that are nonreadable.

4. The method according to claim 3, further comprising the steps of:
determining whether nonreadable logical block addresses are to be reassigned by checking the status of a parameter, said parameter indicating whether nonreadable logical block addresses are to be reassigned.

5. The method according to claim 1, further comprising the step of:
receiving within said storage drive a single command to verify said condition of said storage drive's media.

6. The method according to claim 1, further comprising the steps of:
receiving within said storage drive said command to verify said condition of said storage drivers media from a host computer system;
in response to a receipt of command by said storage drive, said storage drive disconnecting itself from host; and
verifying, by said storage drive, said condition of said media while said storage drive is disconnected from said host.

7. The method according to claim 6, further comprising the step of:
said storage drive disconnecting itself from host by said storage drive becoming offline.

8. The-method according to claim 6, further comprising the steps of:
in response to a completion of said verification, said storage device reconnecting itself to said host.

9. The method according to claim 1, further comprising the steps of:
coupling said storage drive to a host utilizing a SCSI bus;
receiving within said storage drive said command to verify said condition of said storage drive's media utilizing said SCSI bus; and
said command being a SCSI command.

10. The method according to claim 1, further comprising the steps of:
determining, by said storage drive, ones of said plurality of logical block addresses that require error recovery procedures; and
reassigning said ones of said plurality of logical block addresses that require error recovery procedures.

11. The method according to claim 1, further comprising the steps of:
during said verification, maintaining a list of said ones of said plurality of logical block addresses that are not in a readable condition.

12. The method according to claim 1, further comprising the steps of:
verifying said condition of said media without altering data stored on said storage drive.

13. The method according to claim 1, further comprising the steps of:
verifying said condition of said media without altering customer data stored on said storage drive.

14. The method according to claim 1, further comprising the steps of:
said storage drive being coupled to a host computer system;
querying said storage drive by said host computer system during said verification; and
transmitting a response to said query from said storage device to said host computer system during said verification.

15. The method according to claim 14, further comprising the steps of:
querying said storage drive by said host computer system during said verification, said query requesting a completion status; and
transmitting a percentage completion from said storage device to said host computer system during said verification.

16. The method according to claim 14, further comprising the steps of:
querying said storage drive by said host computer system during said verification, said query requesting a list of reassigned logical block addresses; and
transmitting said list from said storage device to said host computer system during said verification.

17. A data processing system including a storage drive for verifying a condition of said storage drive's media, said system comprising:
a command received within said storage device to verify said condition of said storage drive's media;
in response to a receipt of said command, said storage drive attempting to read each one of a plurality of logical block addresses included in said storage drive; and
said storage drive verifying said condition of said media by determining ones of said plurality of logical block addresses that are not in a readable condition.

18. The system according to claim 17, further comprising:
each one of said ones of said plurality of logical block addresses being reassigned that are not in a readable condition to a new logical block address.

19. The system according to claim 17, further comprising:
said storage drive determining ones of said plurality of logical block addresses that are nonreadable;
said storage drive determining whether nonreadable logical block addresses are to be reassigned;
in response to a determination that nonreadable logical block addresses are not to be reassigned, said storage drive leaving said ones of said plurality of logical block addresses that are nonreadable unaltered without reassigning said ones of said plurality of logical block addresses that are nonreadable; and
in response to a determination that nonreadable logical block addresses are to be reassigned, said storage drive reassigning said ones of said plurality of logical block addresses that are nonreadable.

20. The system according to claim 19, further comprising:
a parameter for determining whether nonreadable logical block addresses are to be reassigned by checking the status of said parameter, said parameter indicating whether nonreadable logical block addresses are to be reassigned.

21. The system according to claim 17, further comprising:
said storage drive receiving a single command to verify said condition of said storage drive's media.

22. The system according to claim 17, further comprising:
said storage drive receiving said command to verify said condition of said storage drive's media from a host computer system;
in response to a receipt of command by said storage drive, said storage drive disconnecting itself from host; and
said storage drive verifying said condition of said media while said storage drive is disconnected from said host.

23. The system according to claim 22, further comprising:
said storage drive disconnecting itself from host by said storage drive becoming offline.

24. The system according to claim 22, further comprising:
in response to a completion of said verification, said storage device reconnecting itself to said host.

25. The system according to claim 17, further comprising:
said storage drive coupled to a host utilizing a SCSI bus;
said storage drive receiving said command to verify said condition of said storage drive's media utilizing said SCSI bus; and
said command being a SCSI command.

26. The system according to claim 17, further comprising:
said storage drive determining ones of said plurality of logical block addresses that require error recovery procedures; and
said ones of said plurality of logical block addresses that require error recovery procedures being reassigned.

27. The system according to claim 17, further comprising:
a list of said ones of said plurality of logical block addresses that are not in a readable condition being maintained during said verification.

28. The system according to claim 17, further comprising:
said condition of said media being verified without altering data stored on said storage drive.

29. The system according to claim 17, further comprising:
said condition of said media being verified without altering customer data stored on said storage drive.

30. The system according to claim 17, further comprising:
said storage drive coupled to a host computer system;
said host computer system querying said storage drive during said verification; and
said storage device transmitting a response to said query to said host computer system during said verification.

31. The system according to claim 30, further comprising:
said host computer system querying said storage drive during said verification, said query requesting a completion status; and
said storage device transmitting a percentage completion to said host computer system during said verification.

32. The system according to claim 30, further comprising:
said host computer system querying said storage drive during said verification, said query requesting a list of reassigned logical block addresses; and
said storage device transmitting said list to said host computer system during said verification.

33. A computer program product for verifying a condition of said storage drive's media, said product comprising:
instruction means for receiving within said storage drive a command to verify said condition of said storage drive's media;
in response to a receipt of said command, instruction means for attempting, by said storage drive, to read each one of a plurality of logical block addresses included in said storage drive; and
instruction means for verifying said condition of said media by determining, by said storage drive, ones of said plurality of logical block addresses that are not in a readable condition.

34. The product according to claim 33, further comprising:
instruction means for reassigning each one of said ones of said plurality of logical block addresses that are not in a readable condition to a new logical block address.

35. The product according to claim 33, further comprising:
instruction means for determining, by said storage drive, ones of said plurality of logical block addresses that are nonreadable;
instruction means for determining whether nonreadable logical block addresses are to be reassigned;
in response to a determination that nonreadable logical block addresses are not to be reassigned, instruction means for leaving said ones of said plurality of logical block addresses that are nonreadable unaltered without reassigning said ones of said plurality of logical block addresses that are nonreadable; and
in response to a determination that nonreadable logical block addresses are to be reassigned, instruction means for reassigning said ones of said plurality of logical block addresses that are nonreadable.

36. The product according to claim 35, further comprising:
instruction means for determining whether nonreadable logical block addresses are to be reassigned by checking the status of a parameter, said parameter indicating whether nonreadable logical block addresses are to be reassigned.

37. The product according to claim 33, further comprising:
instruction means for receiving within said storage drive a single command to verify said condition of said storage drive's media.

38. The product according to claim 33, further comprising:
instruction means for receiving within said storage drive said command to verify said condition of said storage drive's media from a host computer system;
in response to a receipt of command by said storage drive, instruction means for disconnecting, by said storage drive, itself from host; and
instruction means for verifying, by said storage drive, said condition of said media while said storage drive is disconnected from said host.

39. The product according to claim 38, further comprising:
instruction means for disconnecting, by said storage drive, itself from host by said storage drive becoming offline.

40. The product according to claim 38, further comprising;
in response to a completion of said verification, instruction means for reconnecting, by said storage device, itself to said host.

41. The product according to claim 33, further comprising:
coupling said storage drive to a host utilizing a SCSI bus;
instruction means for receiving within said storage drive said command to verify said condition of said storage drive's media utilizing said SCSI bus; and
said command being a SCSI command.

42. The product according to claim 33, further comprising:
instruction means for determining, by said storage drive, ones of said plurality of logical block addresses that require error recovery procedures; and
instruction means for reassigning said ones of said plurality of logical block addresses that require error recovery procedures.

43. The product according to claim 33, further comprising:
during said verification, instruction means for maintaining a list of said ones of said plurality of logical block addresses that are not in a readable condition.

44. The product according to claim 33, further comprising:
instruction means for verifying said condition of said media without altering data stored on said storage drive.

45. The product according to claim 33, further comprising:
instruction means for verifying said condition of said media without altering customer data stored on said storage drive.

46. The product according to claim 33, further comprising:
said storage drive being coupled to a host computer system;
instruction means for querying said storage drive by said host computer system during said verification; and
instruction means for transmitting a response to said query from said storage device to said host computer system during said verification.

47. The product according to claim 46, further comprising:
instruction means for querying said storage drive by said host computer system during said verification, said query requesting a completion status; and
instruction means for transmitting a percentage completion from said storage device to said host computer system during said verification.

48. The product according to claim 46, further comprising:
instruction means for querying said storage drive by said host computer system during said verification, said query requesting a list of reassigned logical block addresses; and
instruction means for transmitting said list from said storage device to said host computer system during said verification.
